(19) United States
(12) Patent Application Publication
(10) Pub. No.: US 2024/0216995 A1
(43) Pub. Date: Jul. 4, 2024

(54) PROCESSING POWDERED MATERIAL

(71) Applicant: HEWLETT-PACKARD DEVELOPMENT COMPANY, L.P., Spring, TX (US)

(72) Inventors: Pablo Antonio MURCIEGO RODRIGUEZ, Sant Cugat del Valles (ES); Jorge DIOSDADO BORREGO, Sant Cugat del Valles (ES); David CHANCLON FERNANDEZ, Sant Cugat del Valles (ES)

(73) Assignee: HEWLETT-PACKARD DEVELOPMENT COMPANY, L.P., Spring, TX (US)

(21) Appl. No.: 18/558,140

(22) PCT Filed: Apr. 29, 2021
(86) PCT No.: PCT/US2021/029948

§ 371 Date: Oct. 30, 2023

(51) Int. Cl. B22F 10/73; B33Y 40/10; C04B 35/626

(52) U.S. Cl. CPC B22F 10/73; B33Y 40/10; C04B 35/62645; B22F 2999/00

(57) ABSTRACT

A method in described in which a heated gas is conveyed. A powdered material is introduced to the heated gas at a first location, and powdered material is separated from the heated gas at a second location downstream of the first location. The heated gas causes contaminants in the powdered material to vaporize between the first location and the second location.

### BACKGROUND

In some examples of 3D printing, parts may be formed through the selective solidification of a powered material. After printing, the parts may be removed and the surrounding powdered material may be recovered for subsequent reuse.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is an example of a method for processing powdered material;

FIG. 2 is a further example of a method for processing powdered material;

FIG. 3 is a still further example of a method for processing powdered material;

FIG. 4 is an example of a powder processing system;

FIG. 5 is a further example of a powder processing system; and

FIG. 6 is a still further example of a powder processing system;

### DETAILED DESCRIPTION

In some examples of 3D printing, parts may be formed through the selective solidification of a powered material. After printing, the parts may be removed and the surrounding powdered material may be recovered for subsequent reuse.

In some examples, the powdered material may contain contaminants that were used during the printing process. These contaminants may affect properties of the powdered material, such as the flowability, which may in turn adversely affect the quality of printed parts made from the material. Additionally, the contaminants and/or a product of a reaction involving the contaminants may cause powdered material surrounding the printed parts to agglomerate, which hampers automated processes for removing and recovering powdered material.

By way of example, binder jetting may be used to form metal or ceramic parts through the selective application of a binder. In a particular example of binder jetting, a layer of metal or ceramic powder is deposited onto a bed, and a binding agent is selectively applied to regions of the powder. Liquid components in the binding agent may at least partially evaporate, and the bed is lowered ready for the next layer of powder. This process is then repeated layer-by-layer until the printed build is complete. Once complete, the build is heated to complete the evaporation of the liquid components and to cure the remaining binder to achieve a green part. The green part is then removed from the surrounding powder and cleaned to remove all excess powder. The loose powder surrounding the green part may be recovered for subsequent reuse. However, the powder may be contaminated with components (e.g. solvents and surfactants) of the binding agent. For example, components of the binding agent may leech into other areas of the build after printing. Additionally or alternatively, a vacuum pump may be used to draw air through the build to help remove evaporated components, which may then contaminate other areas of the build.

The cleaned green part is then moved to a sintering furnace in order to burn off the binder and sinter the metal or ceramic particles.

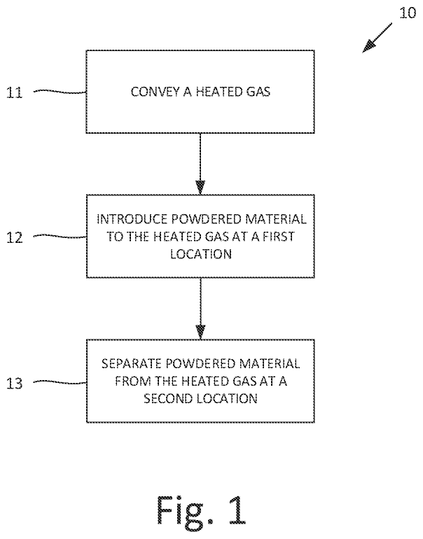

FIG. 1 shows an example of a method for processing powdered material, such as that recovered from a 3D printing process.

The method 10 comprises conveying 11 a heated gas. The heated gas may be conveyed along piping or the like. In one example, the gas may be air. In other examples, the gas may be an inert or non-combustible gas, such as nitrogen or argon.

The method 10 further comprises introducing 12 powdered material to the heated gas at a first location. The powdered material may be material recovered from a 3D printing process. For example, the powdered material may comprise build material, such as a metal or ceramic powder. The powdered material may additionally comprise contaminants, such as solvents, surfactants or adhesive compounds, such as those present in binding agents used during the printing process.

The powdered material is conveyed by the heated gas between the first location and a second location. The heated gas has a temperature higher than the boiling point of contaminants within the powdered material. As a result, the heated gas causes contaminants in the powdered material to vaporize between the first location and the second location. The temperature of the heated gas is, however, lower than the melting point of the build material. The build material therefore remains in a solid state between the first location and the second location. Where the gas comprises a significant oxygen content (e.g. air), the temperature of the heated gas may be lower than the oxidation temperature of the build material to avoid bulk oxidation. In one example, the powdered material may comprise a metal powder contaminated with a water-based, latex binding agent, such as the proprietary binding agent supplied by HP Inc. for use with its range of HP Multi Jet Fusion® and HP Metal Jet Printers®, and the heated gas may have a temperature of around 240° C. In this particular example, vaporization of contaminants may be achieved at lower temperatures. However, a longer period may be required, between the first and second locations, in order vaporize an equivalent quantity of contaminants.

The method 10 then comprises separating 13 powdered material from the heated gas at a second location downstream of the first location. In one example, the powdered material may be separated by cyclonic separation. In other examples, the powdered material may be removed by a different type of inertial separation or by filtration. Moreover, the powdered material may be separated by a combination of different separation mechanisms, such as cyclonic separation followed by filtration.

Vaporized contaminants, previously contained in the powdered material, continue to be in a gaseous state during separation. Consequently, the powdered material separated at the second location has a lower contaminant content than the powdered material introduced at the first location.

The powdered material separated at the second location may be collected and used in a subsequent 3D printing process, and the heated gas comprising the vaporized contaminants may be vented. By introducing powdered material into a flow of heated gas, contaminants in the powdered material may be vaporized and removed in a relatively short period of time.

In addition to vaporizing contaminants, the heat and the mechanical action (e.g. collisions) applied to the powdered material during conveyance may produce changes in the physical properties of the powdered material, particularly the surface properties, which may affect the flowability of the powdered material. Accordingly, the method may also be used to process powdered material devoid of any contaminants, e.g. so as to effect changes in the physical properties of the powdered material. For example, the method may be used to freshen up old powder, or to change the shape and/or size of the powder particles.

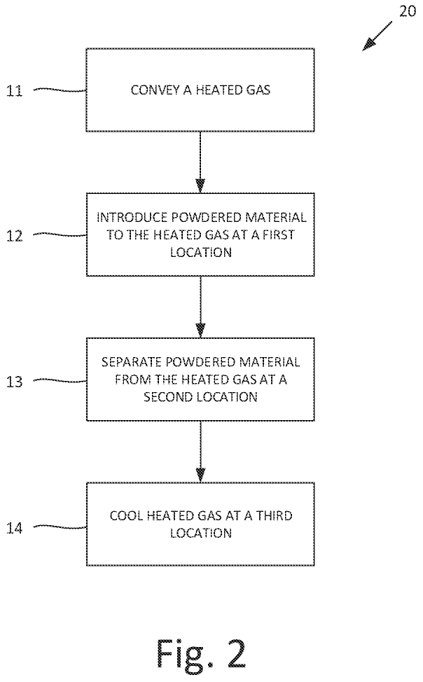

FIG. 2 shows a further example of a method for processing powdered material. The method 20 of FIG. 2 builds upon that of FIG. 1 and comprises conveying 11 a heated gas, introducing 12 powdered material to the heated gas at a first location, and separating 13 powdered material from the heated gas at a second location downstream of the first location. The method 20 further comprises cooling 14 the heated gas at a third location downstream of the second location.

The heated gas may be conveyed by a pump located downstream of the third location. By cooling the heated gas at the third location (i.e. at a location upstream of the pump), a pump having a lower thermal rating may be employed. Additionally or alternatively, by cooling the heated gas, vaporized contaminants in the heated gas may be condensed and removed.

In one example, the heated gas may be cooled using gas upstream of the first location. In this example, conveying the heated gas may be said to comprise conveying a gas and heating the gas. Heating the gas then comprises exchanging heat between the gas at a location upstream of the first location and the heated gas at the third location. As a result, the gas is both heated upstream of the first location and cooled at the third location.

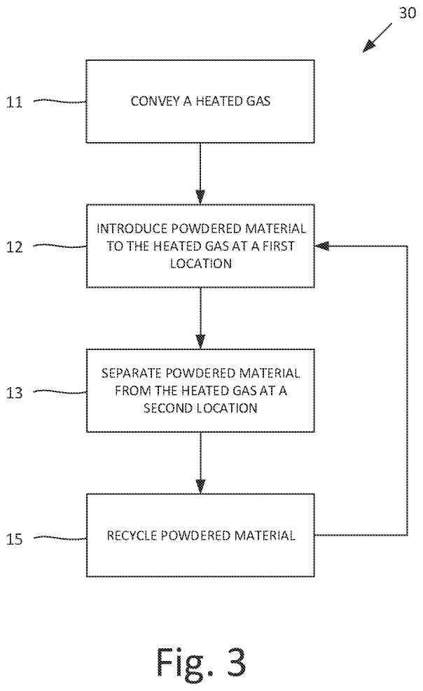

When powdered material is processed using the method of FIG. 1, it is possible that the powdered material continues to comprise an undesirable level of contaminants. FIG. 3 shows a still further example of a method for processing powdered material. The method 30 of FIG. 3, like that of FIG. 1, comprises conveying 11 a heated gas, introducing 12 powdered material to the heated gas at a first location, and separating 13 powdered material from the heated gas at a second location downstream of the first location. The method 30 further comprises recycling 15 powdered material separated at the second location by introducing the separated powdered material to the heated gas at the first location.

The powdered material may be recycled in distinct cycles. For example, a batch of powdered material may be introduced gradually into the heated gas over a period of time. When all of the powdered material has been processed (i.e. introduced and then separated from the heated gas), the batch of powdered material is returned to the first location and the cycle repeated. Recycling in this way may continue for a set number of cycles. Alternatively, the powdered material may be recycled continuously for a set period of time. For example, a batch of powdered material may again be introduced gradually into the heated gas at the first location. However, rather than waiting for all of the powdered material to be processed before recycling, the powdered material separated at the second location may be immediately returned to the batch of powdered material at the first location. Recycling in this way may then continue for a set period of time.

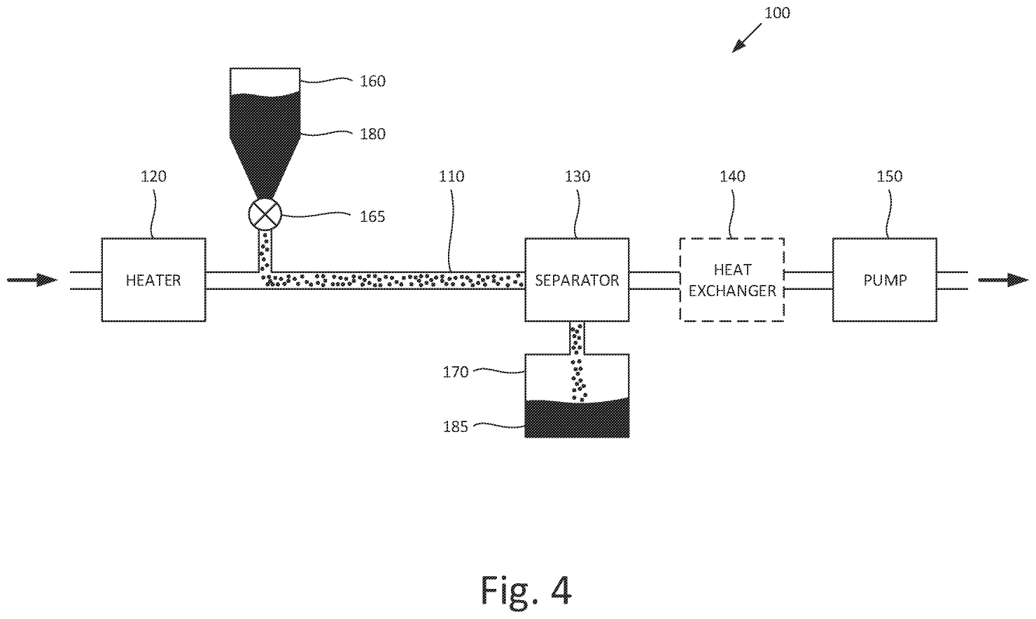

FIG. 4 shows an example of a powder processing system. The system 100 may be used to implement the methods 10,20 of FIGS. 1 and 2. The system 100 comprises piping 110, a heater 120, a separator 130, a heat exchanger 140, a pump 150, a first container 160, a dosing valve 165, and a second container 170.

The pump 150 conveys a gas through the piping 110. In this particular example, the gas is air and is drawn into an inlet of the piping 110 and is exhausted or vented via an outlet of the piping 110.

The heater 120 heats the gas conveyed through the piping 110. In this particular example, the heater comprises resistive heating elements that extend within the piping and across which the gas is drawn. However, alternative means to heat the gas might equally be used. The heater 120 heats the gas to a temperature sufficient to vaporize contaminants within the powdered material to be processed. The heater 120, and thus the temperature of the gas, may be controllable. For example, the temperature of the gas may be controlled according to a characteristic of the powdered material (e.g. the type of build material and/or contaminants, the particle size of the powder), the rate at which powdered material is introduced into the gas, and/or or the flow rate of the gas.

The separator 130 is located downstream of the heater 120 and removes powdered material from the gas. In this particular example, the separator 130 comprises a cyclonic separator. The cyclonic separator may be multi-staged, i.e. comprising upstream and downstream cyclones. For example, the separator 130 may comprise a larger, lower-efficiency cyclone for removing the bulk of the powdered material, and a smaller, higher-efficiency cyclone for removing the remaining powdered material from the gas. The separator 130 may additionally comprise a filter downstream of the cyclonic separator to remove any residual powdered material that may be present in the gas, thereby protecting the heat exchanger 140 and/or the pump 150. Powdered material separated by the separator 130 is collected in the second container 170. Where the separator 130 comprises a filter, the powdered material retained by the filter may be recovered or discarded in a separate process.

The heat exchanger 140 is located downstream of the separator 130 and cools the gas. In this particular example, the pump 150 is located downstream of the heater 120. By cooling the gas at a location upstream of the pump 150, a pump having a lower thermal rating may be employed. Cooling the gas may also cause contaminants in the gas to condense. The condensed contaminants may then be collected and removed, e.g. by means of a drain or sump in the heat exchanger 140. The level of contaminants in the gas may be sufficiently low that the gas may be vented to atmosphere without the need to condense or otherwise separate the volatized contaminants from the gas. In this instance, the heat exchanger 140 need not cool the gas to a temperature below the boiling point of the contaminants.

Although not shown, the system 100 may comprise an exhaust filter, such as a HEPA or ULPA filter, located downstream of the pump 150 to remove any residual powdered material and/or contaminants in the gas before being vented from the piping 110.

The first container 160 receives powdered material 180 to be processed, such as that recovered from a 3D printing process. The powdered material 180 may comprise a composite of build material, such as metal or ceramic powder, and contaminants, such as solvents, surfactants, or other binder components.

The valve 165 introduces powdered material 180 from the first container 170 to the gas at a location downstream of the heater 120 and upstream of the separator 130. In one example, the valve 165 may be actuated by the partial vacuum created by the pump 150 to introduce powdered material to the gas at a fixed rate. In another example, the valve 165 may be controllable (e.g. manually or by means of a controller) to introduce powdered material to the gas at a variable rate that can be controlled. The rate at which powdered material is introduced into the gas may be controlled according to, for example, a characteristic of the powdered material 180 (e.g. the type of build material and/or contaminants, the particle size of the powder), the flow rate of the gas, and/or the temperature of the gas.

Upon introduction, the powdered material 180 is conveyed by the gas along the piping 110. As already noted, the heater 120 heats the gas to a temperature sufficient to vaporize contaminants with the powdered material 180. Consequently, as the powdered material 180 is conveyed along the piping 110, contaminants in the powdered material 180 are vaporized. Powdered material 185 is then separated from the gas by the separator 130 and collected in the second container 170. Vaporized contaminants, previously contained in the powdered material 180, continue to be in a gaseous state during separation. Consequently, the powdered material 185 collected in the second container 170 has a lower contaminant content than the powdered material 180 in the first container 160.

As noted above, the temperature of gas and/or the dispensing rate of the powdered material may be controlled according to a characteristic of the powdered material. For example, a different temperature and/or dispensing rate may be used for powdered materials having different a different particle size, different build material, and/or different contaminants arising from the use of a different binding agent. Additionally or alternatively, the length of the section of piping 110 between the heater 120 and the separator 130 may be adjusted according to a characteristic of the powdered material. For example, the length of the section of piping 110 may be increased in order that the powdered material is heated for a longer period of time. Furthermore, the flow rate of the gas may be controlled according to a characteristic of the powdered material, e.g. by adjusting the speed of the pump or by means of a flow control valve, such as a butterfly valve within the piping 110. Where the separator 130 comprises a cyclonic separator, changes in the flow rate may influence the separation efficiency of the separator. Nevertheless, the cyclonic separator may provide good separation efficiency over a range of flow rates.

The piping 110 may comprise a serpentine section between the heater 120 and the separator 130. As a result, the powdered material 180 may be conveyed between the heater 120 and the separator 130 along a relatively long path in a relatively compact manner.

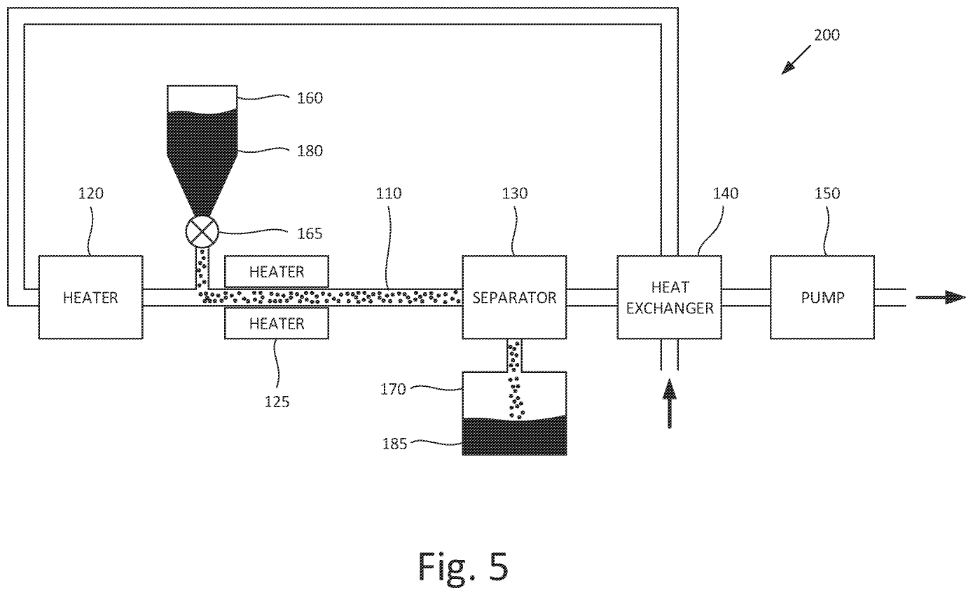

FIG. 5 shows a further example of a powder processing system. The system 200 of FIG. 5 is identical in many respects to that of FIG. 4. However, the system 200 differs in two respects.

First, the heat exchanger 140 responsible for cooling the heated gas downstream of the separator 130 is also used to heat the gas upstream of the heater 120. The heat exchanger 140 therefore reclaims heat extracted from the gas downstream of the separator 130 to heat the gas upstream of the heater 120.

Second, the system 200 comprises a further heater 125 located downstream of the heater 120. More particularly, the further heater 125 is located along a section of the piping 110 along which the powdered material 180 is conveyed. In contrast to the heater 120, which comprises heating elements within the piping 110, the further heater 125 comprises heating elements that surround and heat the piping 110, thereby protecting the further heater 125 from the powdered material 180.

The piping 110 may be insulated to reduce thermal losses. Nevertheless, as the gas is conveyed through the piping 110 between the heater 120 and the separator 130, the temperature of the gas decreases. With the system 100 of FIG. 4, the heater 120 heats the gas to an initial temperature which ensures that, at the exit of the separator 130, the temperature of the gas continues to be above the boiling point of the contaminants. With the system 200 of FIG. 5, the further heater 125 reduces heat loss along the piping 110. As a result, the heater 120 may heat the gas to a lower initial temperature, and thus a heater of lower power may be used.

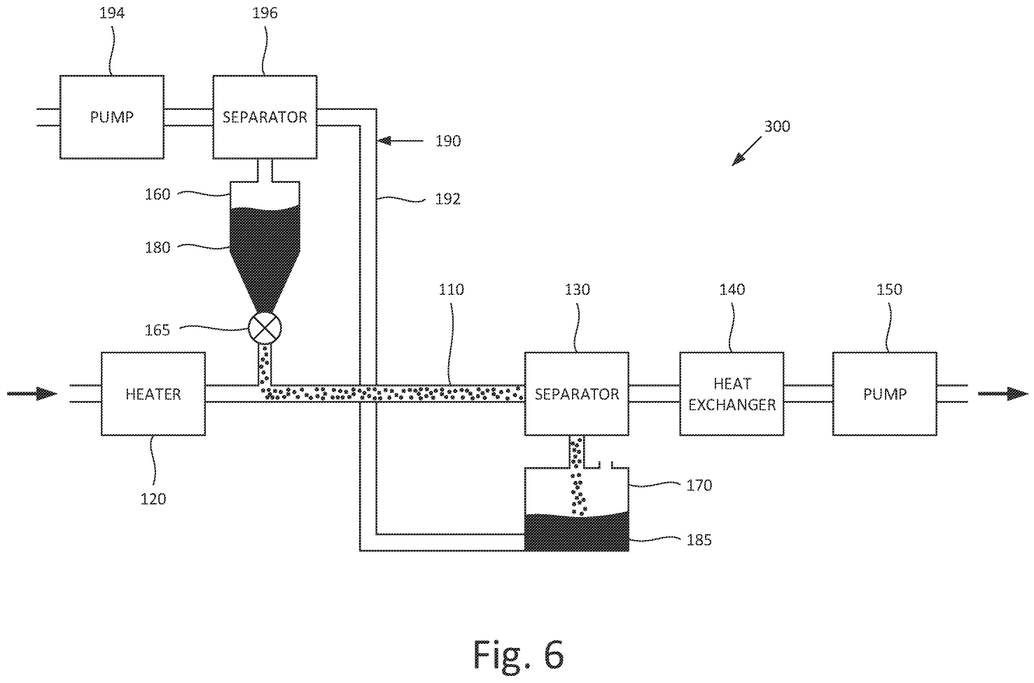

FIG. 6 shows a still further example of a powder processing system. Again, the system 300 of FIG. 6 is identical in many respects to that of FIG. 4. However, the system 300 further comprises a subassembly 190 to recycle powdered material from the second container 170 to the first container 160. The system 300 may therefore be used to implement the method 30 of FIG. 3.

The subassembly 190 comprises piping 192, a pump 194, and a separator 196. The piping 192 extends between the second container 170 and the pump 194. The pump 194 conveys a gas entrained with powdered material 185 from the second container 170 to the separator 196, which is located upstream of the pump 194. The separator 196 separates the powdered material from the gas, and the separated powdered material collects in the first container 160. The subassembly 190 therefore recycles (i.e. moves) powdered material from the second container 170 to the first container 160. In this particular example, the separator 196 is a cyclonic separator. However, other types of separator might equally be used. The subassembly 190 may comprise an exhaust filter, such as a HEPA or ULPA filter, located downstream of the pump 194 to remove any residual powdered material in the gas before being vented. The temperature of the powdered material may be hot and may therefore heat the gas. Accordingly, the subassembly 190 may comprise a heat exchanger located upstream of the pump 194 to cool the gas.

As noted above in connection with the method 30 of FIG. 3, the powdered material may be recycled by the subassembly 190 in distinct cycles or continuously for a set period of time. For example, the pump 194 of the subassembly 190 may operate when the first container 160 is empty, i.e. at the end of a cycle. Alternatively, the pump 194 of the subassembly 190 may operate continuously for a set period of time. The number of cycles and/or the recycle period may be controlled according to, for example, a characteristic of the powdered material 180 (e.g. the type of build material and/or contaminants, the particle size of the powder), the rate at which the powdered material is introduced to the heated gas, the temperature of the heated gas, and/or the rate flow rate of the heated gas.

In each of the example systems 100,200,300 described above, the system comprises a valve 165 for introducing powdered material 180 from the first container 170 to the heated gas. The system may, however, comprise alternative means to introduce the powdered material into the gas. For example, the system may comprise a chamber into which a container of powdered material may be placed. An agitator within the chamber may agitate the container, causing powdered material to be thrown from the container into the heated gas drawn through the chamber. Accordingly, in a more general sense, the system may be said to comprises a mechanism, such as a valve or agitator, to introduce powdered material into the heated gas.

In each of the examples illustrated in FIGS. 4 to 6, the pump 150 is located downstream of heater 120, and the system comprises a heat exchanger 140 to cool the gas upstream of the pump 150. As a result, a pump having a lower thermal rating may be used to convey the gas through the system. Conceivably, the heat exchanger 140 may be omitted and a pump 150 having a higher thermal rating may be used. Alternatively, the heat exchanger 140 may be omitted and the pump 150 may be located upstream of the heater 120, such that gas is pushed rather than pulled through the heater 120 by the pump 150.

Each of the powder processing systems 100,200,300 described above may be integrated into a processing station of a 3D printing system. In one example, the processing station may receive a build unit comprising a build. The processing station may be used to remove printed parts from the build; this may be done manually or in an automated process (e.g. through agitation of the build). The loose powdered material from the build may be recovered and processed using the powder processing system. Finally, the processing station may reload the build unit using the processed powdered material.

The example methods and systems described above are not mutually exclusive and features of one method or system may be used with another method or system. By way of example, the system 300 of FIG. 6 may reclaim heat in the same manner as that of the system 200 of FIG. 5. In another example, powdered material may be recycled with the system 100 of FIG. 4 by manually transporting powdered material from the second container 170 to the first container 160, or by arranging the system 100 such that the powdered material separated by the separator 130 collects directly into the first container 160.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
conveying a heated gas;
introducing powdered material to the heated gas at a first location; and
separating powdered material from the heated gas at a second location downstream of the first location,
wherein the heated gas causes contaminants in the powdered material to vaporize between the first location and the second location.

2. A method as claimed in claim 1, wherein the method comprises cooling the heated gas at a location downstream of the second position.

3. A method as claimed in claim 1, wherein conveying the heated gas comprises conveying a gas and heating the gas, and heating the gas comprises exchanging heat between the gas at a location upstream of the first location and the gas at a location downstream of the second location.

4. A method as claimed in claim 1, wherein powered material is separated from the heated gas by cyclonic separation.

5. A method as claimed in claim 1, wherein the method comprises recycling powdered material separated from the heated gas by introducing the separated powdered material to the heated gas at the first location.

6. A method as claimed in claim 1, wherein conveying the heated gas comprises conveying a gas, heating the gas at a location upstream of the first location, and further heating the gas between the first location and the second location.

7. A powder processing system comprising:
piping;
a pump to convey a gas through the piping;
a heater to heat the gas;
an introduction mechanism to introduce powdered material to the gas; and
a separator to separate powdered material from the gas, the separator being located downstream of the introduction mechanism.

8. A system as claimed in claim 7, wherein the system comprises a heat exchanger located downstream of the separator to cool the gas.

9. A system as claimed in claim 8, wherein the pump is located downstream of the heat exchanger.

10. A system as claimed in claim 8, wherein the heat exchanger reclaims heat from the gas downstream of the heater to heat the gas upstream of the heater.

11. A system as claimed in claim 7, wherein the heater heats the gas to a temperature above the boiling point of contaminants within the powdered material.

12. A system as claimed in claim 7, wherein the separator comprises a cyclonic separator.

13. A system as claimed in claim 7, wherein the piping comprises a serpentine section located between the heater and the separator.

14. A system as claimed in claim 7, wherein the system comprises a first container to receive powdered material, a valve for introducing powdered material from the first container to the gas, a second container to receive powdered material separated by the separator, and a pump to convey powdered material from the second container to the first container.

15. A system comprising:
a container to receive a metal or ceramic powder,
piping to convey a heated gas;
a mechanism to introduce the powder from the container to the heated gas, the heated gas causing contaminants in the powder to vaporize; and
a separator to separate the powder from the heated gas.
